(19) United States
(12) Patent Application Publication
(10) Pub. No.: US 2026/0296232 A1
(43) Pub. Date: Oct. 1, 2026

(54) CHARGING INLET

(71) Applicant: Yazaki Corporation, Tokyo (JP)

(72) Inventors: Teruhiko OOIKE, Kakegawa-shi (JP); Shinichi KAMURA, Kakegawa-shi (JP)

(73) Assignee: Yazaki Corporation, Tokyo (JP)

(21) Appl. No.: 19/550,418

(22) Filed: Feb. 26, 2026

(30) Foreign Application Priority Data
Apr. 1, 2025 (JP) 2025-060240

(51) Int. Cl. B60L 53/16; H01R 13/502; H01R 13/52; H01R 24/76

(52) U.S. Cl. CPC B60L 53/16; H01R 13/502; H01R 13/5213; H01R 24/76; H01R 2201/26

(57) ABSTRACT

A charging inlet includes a housing, a cap, and a biasing mechanism. In the housing, a second connection portion to which a mating connector is connected and a cap support portion are provided. The cap includes an axial support portion being rotatably attached to the cap support portion so as to expose the second connection portion at an open position while covering the second connection portion at a closed position. The biasing mechanism is arranged between the housing and the axial support portion to bias the axial support portion toward a direction separating from the housing. The biasing mechanism includes a spring, a holder accommodating the spring, and a contact portion arranged between the holder and the axial support portion to come into contact with the axial support portion.

### TECHNICAL FIELD

The present invention relates to a charging inlet.

### BACKGROUND ART

A charging inlet equipped in an electric vehicle and a hybrid vehicle and to which a charging connector provided in a charging station and the like is connected is known.

FIGS. 7 and 8 are showing a charging inlet 501 that is disclosed in Patent Document 1. The charging inlet 501 includes a housing 502, a cap 503, a pin 542 attached to an axial support portion 532 of the cap 503, a compression spring 544, and a holder 545 accommodating the compression spring 544.

In the housing 502, a first connection portion 505 and a second connection portion 506 to which the charging connector is connected, a pair of bearings 541 axially supporting the pin 542, and an accommodating concave portion 540 accommodating the compression spring 544 and the holder 545 are provided.

The cap 503 is configured to, at an open position, expose the second connection portion 506, and at a closed position, cover the second connection portion 506.

The compression spring 544 and the holder 545 are biasing the axial support portion 532 of the cap 503 toward a direction separating from the housing 502. Also, the holder 545 comes into contact with the abutting portion 533 of the axial support portion 532 at the open position to keep the cap 503 at the open position.

### Citation List

### Patent Documents

[Patent Document 1] JP 2024-60745A

### SUMMARY OF THE INVENTION

### Technical Problem

The above-described charging inlet 501 of Patent Document 1 is configured with a structure where the axial support portion 532 made from the resin and the holder 545 made from the resin are sliding when the cap 503 is opened and closed such that there is the wear occurred in both members by repeating the opening and closing.

Therefore, the goal of the present invention is to reduce the wear of a member in the charging inlet.

### Solution to Problem

The present invention is a charging inlet, comprising a housing in which a connection portion to which a mating connector is connected and a cap support portion are provided; a cap including an axial support portion being rotatably attached to the cap support portion so as to expose the connection portion at an open position while covering the connection portion at a closed position; and a biasing mechanism arranged between the housing and the axial support portion to bias the axial support portion toward a direction separating from the housing, wherein the biasing mechanism includes a spring, a holder accommodating the spring, and a contact portion arranged between the holder and the axial support portion to come into contact with the axial support portion.

### Effect of the Invention

According to the present invention, it is possible to reduce the wear of a member in the charging inlet.

### BRIEF DESCRIPTION OF THE DRAWINGS

FIG. 1 is a view showing a charging inlet according to an embodiment of the present invention.

FIG. 2 is a view showing a biasing mechanism provided in the charging inlet of FIG. 1.

FIG. 3 is an exploded view of the biasing mechanism of FIG. 2

FIG. 4 is a view viewing a holder of FIG. 3 from an opposite side.

FIG. 5 is a view showing a state in which a cap of the charging inlet of FIG. 1 is positioned at an open position.

FIG. 6 is a view showing a state in which the cap of FIG. 5 is positioned at a closed position.

FIG. 7 is a view showing a conventional charging inlet.

FIG. 8 is a view showing a biasing mechanism provided in the charging inlet of FIG. 7.

### DESCRIPTION OF EMBODIMENTS

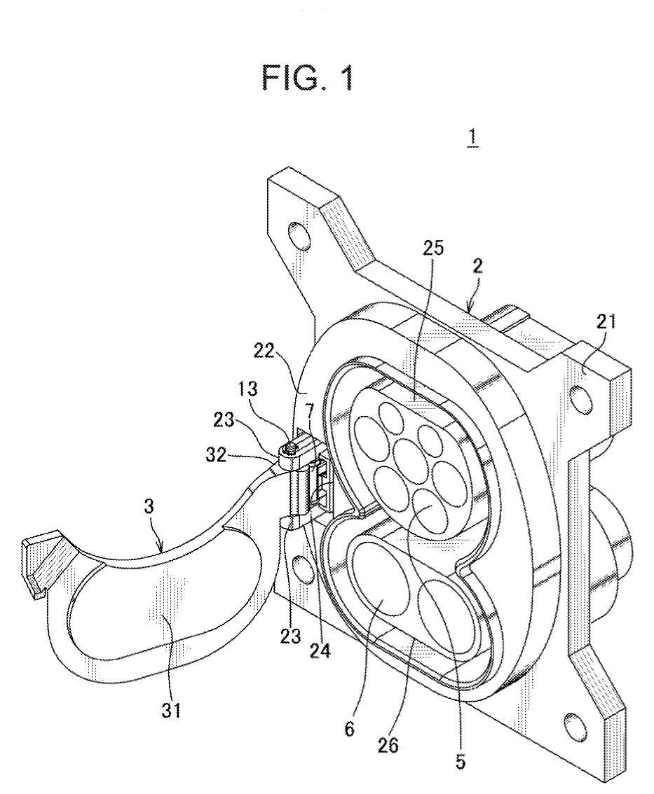

A “charging inlet” according to an embodiment of the present invention will be described by referring to FIGS. 1 to 6.

A charging inlet 1 shown in FIG. 1 is a configuration equipped in an electric vehicle and a hybrid vehicle, and to which a charging connector provided in a charging station or the like is connected. The charging inlet 1 is called a “charging plug” or a “charging port”.

The charging inlet 1 includes a housing 2, a cap 3, and a biasing mechanism 4.

In the housing 2, a first connection portion 5 and a second connection portion 6, an outer circumferential portion 22 surrounding the first connection portion 5 and the second connection portion 6, a flange portion 21 protruding from the outer circumferential portion 22, an accommodation concave portion 24 accommodating the biasing mechanism 4, and a pair of cap support portions 23 are provided.

The first connection portion 5 and the second connection portion 6 are portions to which the above-described charging connector (being equivalent to a “mating connector”) is connected. The first connection portion 5 is configured from a terminal accommodation portion 25 configured from a synthetic resin, and a terminal accommodated in the terminal accommodation portion 25.

The second connection 6 (being equivalent to a “connection portion”) is configured from a terminal accommodation portion 26 configured from the synthetic resin, and a terminal accommodated in the terminal accommodation portion 26.

The outer circumferential portion 22 and the flange portion 21 are configured from the synthetic resin to be integrally molded with the terminal accommodation portions 25, 26. The flange portion 21 is a portion to be bolted to a vehicle body.

The accommodation concave portion 24 is formed as being recessed from a front surface of the outer circumferential portion 22. Then, the recitation as the “front surface of the outer circumferential portion 22” is an expression based on a paper orientation of FIG. 1, and it may not be coincided with an orientation thereof in a state in which the charging inlet 1 is actually equipped in the vehicle.

The pair of cap support portions 23 are arranged at both sides of the accommodation concave portion 24. In each cap support portion 23, an elongated hole is formed through a pin 13 described below.

The cap 3 is configured from the synthetic resin. The cap 3 integrally includes a plate-shaped cap main body 31, and an axial support portion 32 being continuous to one end of the cap main body 31.

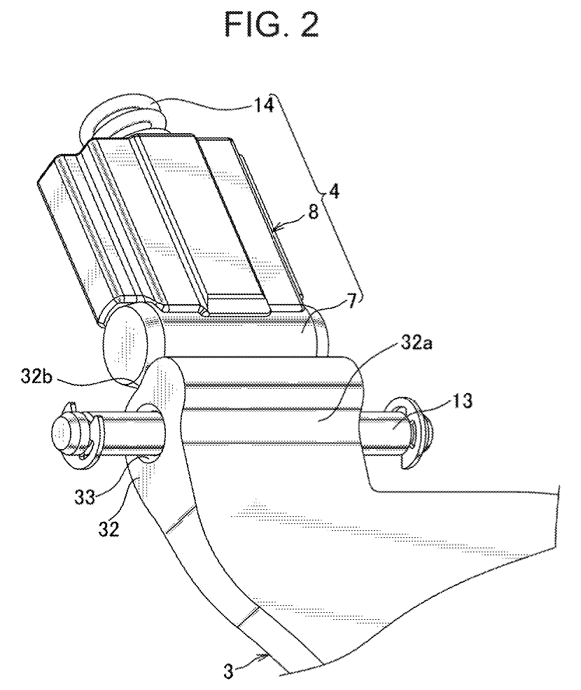

As shown in FIG. 2, a penetration hole 33 is formed in the axial support portion 32, and the pin 13 is through this penetration hole 33. Also, in the axial support portion 32, a first abutting portion 32a and a second abutting portion 32b to which a contact portion 7 described below is abutting are formed. The axial support portion 32 is arranged between a pair of cap support portions 23. Also, one end side of the pin 13 is through the elongated hole of the cap support portion 23 at one side, and the other end side of the pin 13 is through the elongated hole of the cap support portion 23 at the other side.

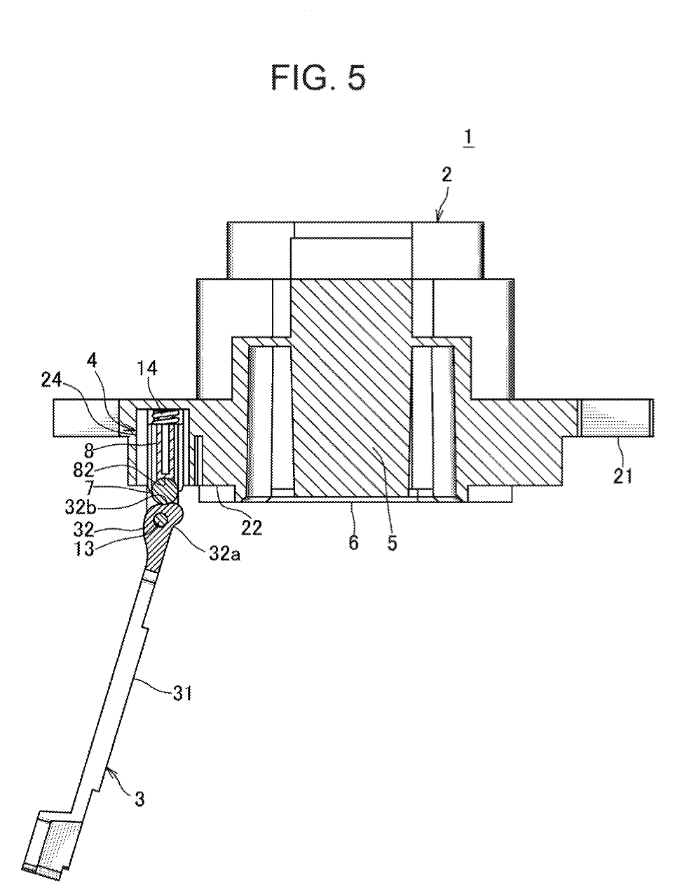

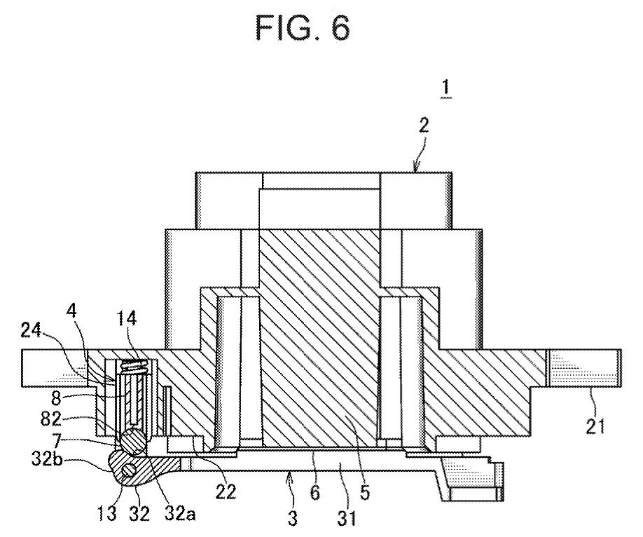

The cap 3 rotates around the pin 13 as a center to expose the second connection portion 6 at the open position shown in FIGS. 1 and 5, while covering the second connection portion 6 at the closed position shown in FIG. 6.

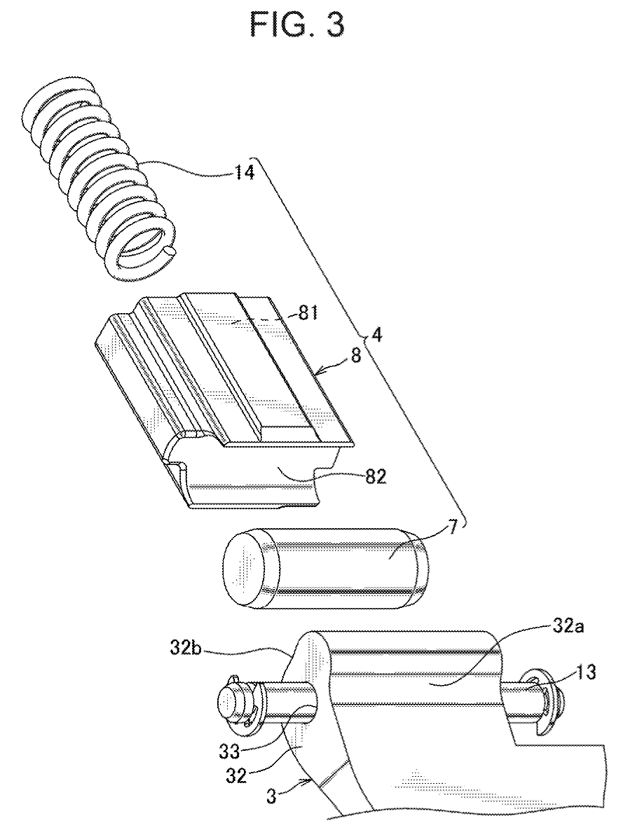

The biasing mechanism 4 is a configuration being arranged between the housing 2 and the axial support portion 32 to bias the axial support portion 32 in a direction separating from the housing 2 (in FIGS. 5 and 6, downward in the paper surface). In the present example, the biasing mechanism 4 is accommodated in the accommodation concave portion 24. As shown in FIGS. 2 and 3, the biasing mechanism 4 includes a spring 14, a holder 8 accommodating this spring 14, and a contact portion 7 that is arranged between this holder 8 and the axial support portion 32 to come into contact with the axial support portion 32.

The spring 14 is a compression coil spring formed by winding a wire material into a coil shape. One end of the spring 14 is in contact with a deep surface of the accommodation concave portion 24, and the other end of the spring 14 is in contact with an inner surface of the holder 8.

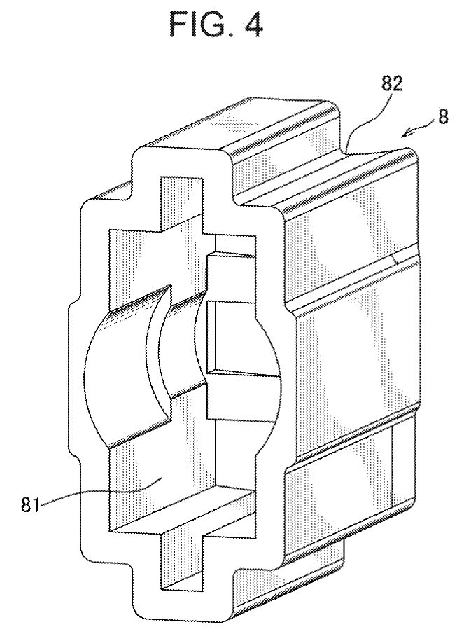

The holder 8 is configured from the synthetic resin. As shown in FIG. 4, the holder 8 has an accommodation space 81 opening at one direction, and the other end of the spring 14 is accommodated in this accommodation space 81. Also, as shown in FIG. 3, on the outer surface of the holder 8, a curved surface 82 being in contact with the outer circumferential surface of the contact portion 7 is formed.

The contact portion 7 is configured from the metal in the present example. Also, the contact portion 7 is formed in a cylindrical shape. The curved surface 82 of the above-described holder 8 is along approximately half (half circumference) of the outer circumferential surface of the contact portion 7. Therefore, the contact portion 7, without slipping off, is kept between the holder 8 and the axial support portion 32.

In the charging inlet 1, when the cap 3 is opened and closed, the axial support portion 32 slides against the outer circumferential surface of the contact portion 7. Then, in the case when the cap 3 is at the closed position, the contact portion 7 is abutting against the first abutting portion 32a of the axial support portion 32 so as to keep the cap 3 at the closed position. Also, in the case when the cap 3 is at the open position, the contact portion 7 is abutting against the second abutting portion 32b of the axial support portion 32 so as to keep the cap 3 at the open position.

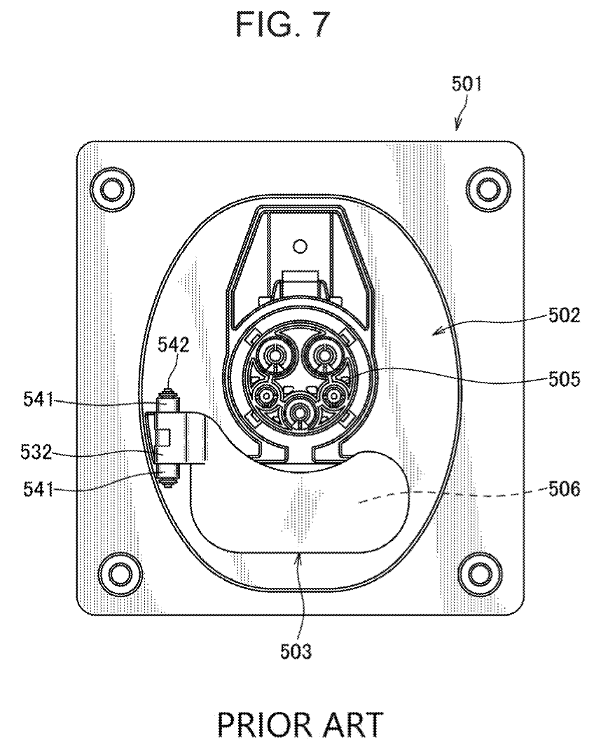

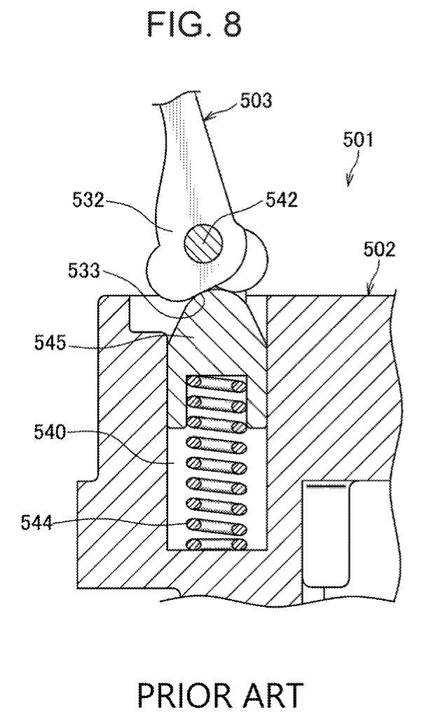

In the conventional product (referring to FIGS. 7 and 8), there is a problem that with the structure where the axial support portion 532 made from the resin and the holder 545 made from the resin are sliding when the cap 503 is opened and closed, there is the wear occurred in both members by repeating the opening and closing. Regarding this problem, in the charging inlet 1, the contact portion 7 being rotatable between the holder 8 made from the resin and the axial support portion 32 made from the resin is interposed. Also, the contact portion 7 is made from the metal with a lower friction coefficient than that of the resin. Due to such arrangements, it is possible to reduce the wear occurred in the holder 8 and the axial support portion 32 than the conventional product. Thus, in this manner, the wear in each member is reduced such that it is possible to suppress abnormal noise and changes in the feel when opening and closing the cap 3.

According to the above-described embodiment, it is recited that the axial support portion 32 is made from the resin, and the contact portion 7 is made from the metal; however, the present invention is not limited thereto, and a combination of materials where the friction coefficient between the axial support portion and the contact portion becomes lower can be suitable adopted.

Hereinbefore, the above-described embodiment has been shown merely as a representative embodiment of the present invention, and the present invention is not limited to this embodiment. That is, various modifications can be constituted without departing from the spirit of the present invention. As long as such modifications still have the structure according to the present invention, they are certainly included in the scope of the present invention.

### REFERENCE SIGNS LIST

1 charging inlet

2 housing

3 cap

4 biasing mechanism

6 second connection portion (connection portion)

7 contact portion

8 holder

14 spring

23 cap support portion

32 axial support portion

What is claimed is:

1. A charging inlet, comprising:
a housing in which a connection portion to which a mating connector is connected and a cap support portion are provided;
a cap including an axial support portion being rotatably attached to the cap support portion so as to expose the connection portion at an open position while covering the connection portion at a closed position; and
a biasing mechanism arranged between the housing and the axial support portion to bias the axial support portion toward a direction separating from the housing,
wherein the biasing mechanism includes a spring, a holder accommodating the spring, and a contact portion arranged between the holder and the axial support portion to come into contact with the axial support portion.

2. The charging inlet according to claim 1, wherein the contact portion is formed in a cylindrical shape.

3. The charging inlet according to claim 2, wherein a curved surface in contact with an outer circumferential surface of the contact portion is formed on an outer surface of the holder.

4. The charging inlet according to claim 1, wherein the contact portion is made from a metal.

5. The charging inlet according to claim 1, wherein an accommodation concave portion accommodating the biasing mechanism is provided in the housing.
